(19) United States
(12) Patent Application Publication
(10) Pub. No.: US 2020/0179964 A1
(43) Pub. Date: Jun. 11, 2020

(54) COMPRESSED AIR FOAM MIXING SYSTEM

(71) Applicant: Exira Capital, L.L.C., Las Vegas, NV (US)

(72) Inventor: Kyle B. Johnson, Booneville, IA (US)

(21) Appl. No.: 16/210,152

(22) Filed: Dec. 5, 2018

(51) Int. Cl. B05B 7/00; B01F 3/04

(52) U.S. Cl. CPC B05B 7/0025; B01F 5/0406; B01F 3/04446

(57) ABSTRACT

A compressed air foam mixing system that has a mixing device connected to a discharge port of a tank. The mixing device receives fluid from the tank and pressurized air from the tank or alternatively directly from a source of pressurized air. The fluid and pressurized air are combined within the mixing device to form a foam.

### BACKGROUND OF THE INVENTION

The present invention is directed to a compressed air foam mixing system and more particularly a system for producing antibacterial or biodecontaminant foam to kill molds, yeast and the like.

Compressed air foam systems are known in the art. Generally, these devices are used to produce foam to combat fires. A typical system includes a foam injector system, a water pump system, and an air system including an air compressor for supplying air under pressure. While useful, these systems are complex in their design, have many parts, and are expensive to produce. Accordingly, a need exists in the art for a system that addresses these deficiencies.

An objective of the present invention is to provide a compressed air foam system that has a simple design and is inexpensive to manufacture.

These and other objectives will be apparent to those having ordinary skill in the art based upon the following written description, drawings, and claims.

### SUMMARY OF THE INVENTION

A compressed air foam mixing system includes a mixing device connected to a discharge port of a tank that contains a fluid. The mixing device has a hollow, elongated body with a first end, a second end, and a side wall. The first end has an end wall that surrounds a central opening. The central opening aligns with a central bore that extends from the first end of the elongated body to a mixing chamber and the mixing chamber extends from the central bore to the second end of the elongated body.

The central bore is formed by an inner wall that extends from the first end of an elongated body to a shoulder that is preferably angled. The end wall has a plurality of apertures that surround the central opening. The apertures are aligned and in communication with a plurality of bores that extend through the inner wall and preferably are angled toward, and in communication with, the central bore.

A pick-up tube is connected to the central bore of the mixing device and extends from the mixing device to the bottom of the tank. The pick-up tube supplies fluid, under pressure, to the mixing chamber of the mixing device. Pressurized air is supplied to the mixing chamber either from the tank through the bores that surround the central bore or directly from a source of pressurized air through an air port in the side wall of the mixing device.

### BRIEF DESCRIPTION OF THE DRAWINGS

FIG. 1 is a top perspective view of a mixing device;

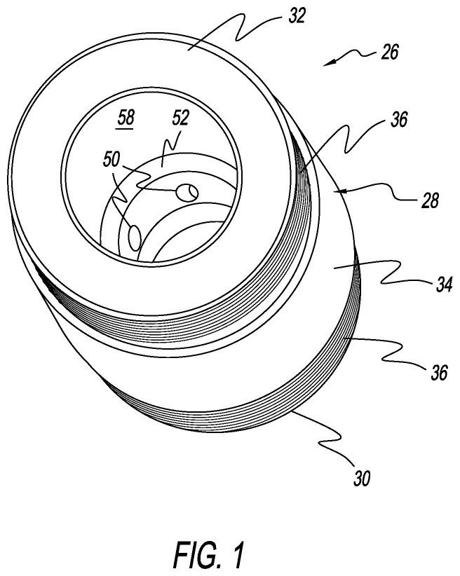

FIG. 2 is a bottom perspective view of a mixing device;

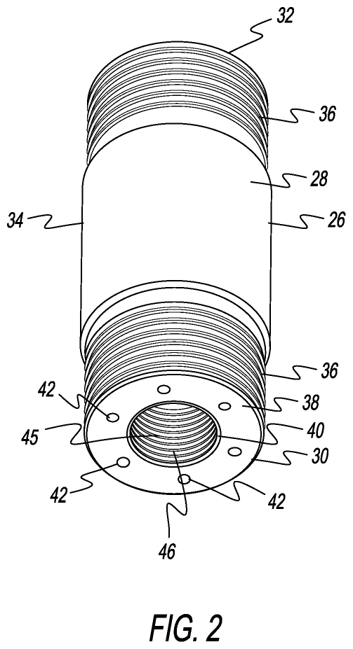

FIG. 3 is a side sectional view of a mixing device; and

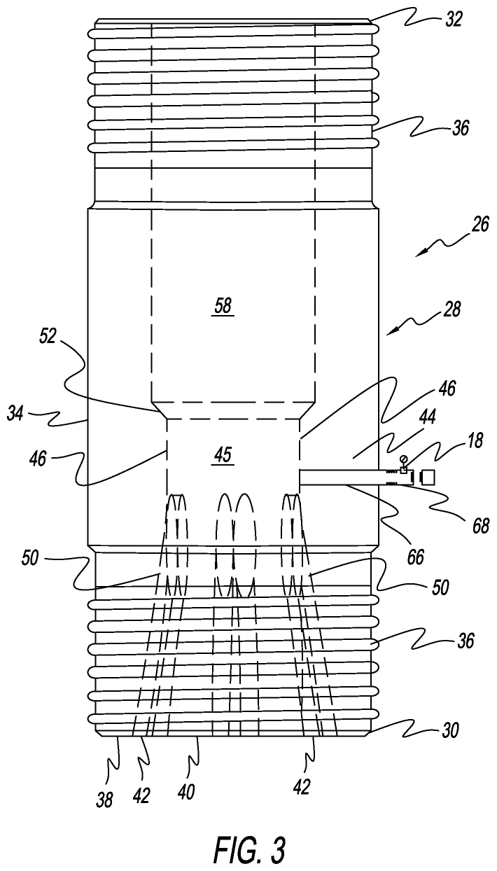

FIG. 4 is a side sectional view of a compressed air foam mixing system.

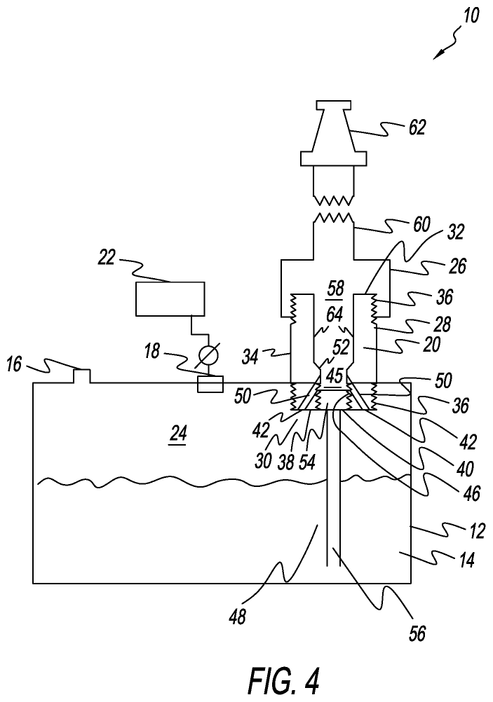

### DETAILED DESCRIPTION OF THE PREFERRED EMBODIMENTS

Referring to the Figures, a compressed air foam mixing system 10 includes a tank 12 filled with fluid 14. Preferably, the fluid 14 is an antibacterial or biodecontaminant for killing molds, yeast, and the like. The tank 12 has an air port 16, an air pump valve 18, and a threaded discharge port 20. The air pump valve 18 is connected to a source of pressurized air 22 and provides pressurized air 24 to the tank.

A mixing device 26 is threadably connected to the discharge port 20. While the mixing device 26 is of any size, shape, and structure, in one example, the mixing device 26 has an elongated, hollow, cylindrical body 28 having a first end 30, a second end 32, and a side wall 34. Adjacent each end 30 and 32, an outer surface 36 of the side wall 34 is threaded.

The first or lower end 30 of the mixing device 26 has an end wall 38 that surrounds a central opening 40. The end wall 38 has a plurality of apertures 42 that surround the central opening 40. Extending from the end wall 38, into the hollow body 28, is a partial inner wall 44 that is adjacent the central opening 40 to form a central bore 45. An inner surface 46 of the central bore 45 is threaded to threadably receive a pick-up tube 48. A plurality of bores 50 extend from, and are in alignment with, the apertures 42. Bores 50 extend from the apertures 42 to an inner shoulder 52 that is formed by the termination of the inner wall 44. Preferably, the shoulder 52 is angled outwardly from the central bore 45 and upwardly toward the second end 32. Alternatively, the bores 50 are angled upwardly, and inwardly, and are in communication with the central bore 45.

The pick-up tube 48 has a threaded head 54 and is connected to, and in communication with, an elongated conduit or hose 56. The threaded head 54 is connected to the inner surface 46 of the central bore 45. The hose 56 extends from the head 54 to the bottom of the tank 12.

The central bore 45 and the plurality of bores 50 are in communication with a mixing chamber 58. The mixing chamber 58 extends from the shoulder 52 of the inner wall 44 to the second end 32 of the elongated body 28. A hose 60 having a nozzle 62 is threadably attached to the threaded outer surface 36 of the second end 32.

In operation, pressurized air 24 is supplied to the tank 12 from the source of pressurized air 22 through the air pump valve 18. When the nozzle 62 is activated and opened the pressurized air 24 flows through the plurality of bores 50 and into the mixing chamber 58. The pressurized air 24 also acts upon the fluid 14 causing the fluid 14 to flow through the pick-up tube 48, into the central bore 45, and finally into the mixing chamber 58. The diameter of bores 50 preferably ⅛ inches, the diameter of the central bore 45 preferably ¾ inches, and the diameter of the mixing chamber 58 preferably ⅞ inches, causes the pressurized air 24 to mix with the fluid 14 to create a foam 64. The foam 64 flows from the mixing chamber 50, through the hose 60, and out the nozzle 62.

In an alternative embodiment, the elongated body 28 has an air port 66 in the side wall 34 to which the source of pressurized air 22 is connected via a conduit 68. The air pump valve 18 is connected to the conduit 68. This embodiment works the same as the previous example except pressurized air 24 is supplied through air port 66 instead of directly to the tank 12.

From the above discussion and accompanying figures and claims it will be appreciated that a compressed air foam mixing system 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A compressed air foam mixing system, comprising:
a tank filled with fluid and having a discharge port;
a mixing device having a hollow elongated body with a first end, a second end, and a side wall;
the first end having a central bore and a plurality of surrounding bores that extend toward the second end and are in communication with a mixing chamber; and
a pick-up tube connected to the mixing chamber.

2. The system of claim 1 wherein an air pump valve is connected to the tank and adapted to provide pressurized air to the tank.

3. The system of claim 1 wherein an air pump valve is connected to an air port in the side wall of the mixing device and is adapted to provide pressurized air to the mixing device.

4. The system of claim 1 wherein the plurality of bores surrounding the central bore and extend through an inner wall to a shoulder and an inner surface of the inner wall forms the central bore.

5. The system of claim 4 wherein the shoulder is angled outwardly from the central bore and upwardly toward the second end of the hollow elongated body.

6. The system of claim 1 wherein the pick-up tube has a head that is threadably received within the central bore and a conduit that extends from the head to a bottom of the tank.

7. The system of claim 1 wherein a hose is connected to the second end of the mixing device at one end and to a nozzle at the opposite end.
